(19) United States
(12) Patent Application Publication
(10) Pub. No.: US 2025/0173595 A1
(43) Pub. Date: May 29, 2025

(54) OBSERVABLE BACKPROPAGATION FOR IMPROVING THE DEPTH OF A QUANTUM SIMULATION

(71) Applicant: International Business Machines Corporation, Armonk, NY (US)

(72) Inventors: Kunal Sharma, White Plains, NY (US); Minh Tran, Cambridge, MA (US); Antonio Mezzacapo, Brooklyn, NY (US)

(21) Appl. No.: 18/521,318

(22) Filed: Nov. 28, 2023

(51) Int. Cl. G06N 10/60

(52) U.S. Cl. CPC G06N 10/60

(57) ABSTRACT

One or more systems, devices, computer program products and/or computer-implemented methods of use provided herein relate to observable backpropagation for improving the depth of a quantum simulation. A system can comprise a memory that can store computer-executable components. The system can further comprise a processor that can execute the computer-executable components stored in the memory, wherein the computer-executable components can comprise a quantum computation component that can apply state propagation to a first part of a quantum circuit, on a quantum computer. The computer-executable components can further comprise a classical computation component that can apply observable backpropagation to a second part of the quantum circuit, on a high-performance classical computer.

### BACKGROUND

The subject disclosure relates to quantum computing and, more specifically, to observable backpropagation for improving the depth of a quantum simulation.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits that comprise superpositions of both 0 and 1, can entangle multiple quantum bits, and use interference. Executing operations on a quantum computer can involve the application of quantum gates on qubits, and qubits can often be connected by two-qubit quantum gates in a quantum circuit. While quantum devices can be used to solve a variety of problems, many such problems can involve deep quantum circuits beyond capabilities of existing quantum computers. The depth of a quantum circuit can be defined as the number of layers of quantum gates that can be applied in parallel. Further, connections between gates in a quantum circuit can be noisy. Thus, a higher number of quantum gates can increase the depth and noise associated with quantum computations.

The above-described background description is merely intended to provide a contextual overview regarding quantum computing and quantum devices and is not intended to be exhaustive.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable observable backpropagation for improving the depth of a quantum simulation are discussed.

According to an embodiment, a system is provided. The system can comprise a memory that can store computer-executable components. The system can further comprise a processor that can execute the computer-executable components stored in the memory, where the computer-executable components can comprise a quantum computation component that can apply state propagation to a first part of a quantum circuit, on a quantum computer. The computer-executable components can further comprise a classical computation component that can apply observable backpropagation to a second part of the quantum circuit, on a high-performance classical computer. Such embodiments of the system can provide a number of advantages, including reducing the depth of a quantum simulation to be performed on a quantum computer by executing deep quantum circuits using a combination of quantum computing and classical computing.

In one or more embodiments of the aforementioned system, a division component can divide the quantum circuit into the first part and the second part. In one or more embodiments of the aforementioned system, applying the state propagation can comprise preparing a quantum state corresponding to the first part of the quantum circuit. In one or more embodiments of the aforementioned system, applying the observable backpropagation can comprise computing an effective observable evolved under the second part of the quantum circuit. In one or more embodiments of the aforementioned system, a measurement component can measure the effective observable with respect to the quantum state corresponding to the first part of the quantum circuit to generate an outcome. In one or more embodiments of the aforementioned system, a post processing component can process the outcome to obtain an observable expectation value for the quantum circuit. In one or more embodiments of the aforementioned system, applying the state propagation to the first part of the quantum circuit and the observable backpropagation to the second part of the quantum circuit can increase an effective depth of the quantum circuit. Such embodiments of the system can provide a number of advantages, including reducing the depth of a quantum simulation to be performed on a quantum computer, pushing capabilities of near-term quantum devices for executing deep quantum circuits and reducing a cost of estimating expectation values of observables using error mitigation on noisy quantum devices.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can employ observable backpropagation for improving the depth of a quantum simulation in accordance with one or more embodiments described herein.

FIG. 2 illustrates a block diagram of an example, non-limiting system that can measure an effective observable with respect to a quantum state for improving the depth of a quantum simulation in accordance with one or more embodiments described herein.

FIG. 3 illustrates a block diagram of an example, non-limiting system that can obtain an observable expectation value for a quantum circuit for improving the depth of a quantum simulation in accordance with one or more embodiments described herein.

FIG. 4 illustrates a diagram of an example, non-limiting quantum circuit that can be divided into two parts for improving the depth of a quantum simulation in accordance with one or more embodiments described herein.

FIG. 5 illustrates a diagram of an example, non-limiting quantum circuit divided into two parts for improving the depth of a quantum simulation in accordance with one or more embodiments described herein.

FIG. 6 illustrates a diagram of an example, non-limiting heavy hex lattice showing a kicked Ising model in accordance with one or more embodiments described herein.

FIG. 7 illustrates a diagram of an example, non-limiting table showing a comparison of an overall sampling cost and an error mitigation cost for a quantum simulation in accordance with one or more embodiments described herein.

FIG. 8 illustrates a flow diagram of an example, non-limiting process for estimating an observable expectation value in accordance with one or more embodiments described herein.

FIG. 9 illustrates a flow diagram of an example, non-limiting method that can employ observable backpropagation for improving the depth of a quantum simulation in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Near-term quantum devices can enable quantum computations with a limited number of depths, due to different issues. For example, quantum devices can be used to solve a variety of problems that can often involve the execution of deep quantum circuits. Execution of such deep quantum circuits can exceed the capabilities of near-term quantum devices because near-term quantum devices have a limited depth that can be traversed, due to hardware noise. For example, executing operations on a quantum computer can involve the application of quantum gates on qubits, and qubits can often be connected by two-qubit quantum gates in a quantum circuit. Connections between gates in a quantum circuit can be noisy and not ideal. Thus, increasing the number of gates can increase the depth and noise associated with quantum computations, and after a certain point, a quantum circuit can become entirely noisy. That is, there can be a threshold beyond which extracting useful information by executing a quantum circuit can be challenging. In this regard, some existing approaches can combine quantum and classical resources. However, such approaches can be restricted to the use of variational quantum algorithms or circuits. Thus, techniques to improve the depth of a quantum simulation on near-term quantum devices using generic quantum circuits can be desirable.

Various embodiments of the present disclosure can be implemented to produce a solution to these problems. Embodiments described herein include systems, computer-implemented methods, and computer program products that can improve the depth of a quantum simulation using observable backpropagation. Improving the depth of the quantum simulation can be performed by combining state propagation and observable backpropagation. State propagation can refer to an action of applying a quantum circuit to a quantum state (e.g., an initial quantum state), and observable backpropagation, or Heisenberg-picture simulation, can be a formalism wherein the quantum circuit can be applied to an observable instead of applying the quantum circuit a quantum state. In various embodiments, state propagation can be applied to a first part of a quantum circuit and observable backpropagation can be applied to a second part of the quantum circuit. The state propagation can be implemented on a quantum hardware, whereas the observable backpropagation can be computed classically using high-performance computing because observable backpropagation can generally be a difficult computation.

More specifically, in various embodiments, a quantum circuit, U can be decomposed into two parts: U_{Q} and U_{C}, such that U=U_{C}U_{Q}. Since near-term quantum computers can be limited by depth due to hardware noise, U_{Q} can be chosen such that observable expectation values can be estimated with a high accuracy. The evolution of an observable O with respect of U_{C}^{†}, that is, U_{C}^{†}OU_{C} can be estimated on a high-performance classical computer. For example, assuming O=ΣᵢαᵢPᵢ, the high-performance classical computer can compute U_{C}^{†}PᵢU_{C} for each i and determine the effective O′≡U_{C}^{†}OU_{C}=ΣᵢβᵢPᵢ, where βᵢ represent the updated coefficients. For an efficient implementation of the method disclosed herein, terms in O′ corresponding to βᵢ below a threshold can be discarded. The threshold step can account for the total error allowed in estimating the observable expectation. Tr(OU|Ψ [symbol] [symbol] Ψ|U^{†}). Thereafter, quantum experiments can be run to estimate Tr(O′U_{Q}|Ψ [symbol] [symbol] Ψ|U_{Q}^{†}). As part of the quantum experiments, a state U_{Q}|Ψ [symbol] can first be prepared, followed by measurement of the expectation value. Tr(PᵢU_{Q}|Ψ [symbol] [symbol] Ψ|U_{Q}^{†}), where Pᵢ corresponds to O′=ΣᵢβᵢPᵢ. To estimate the expectation value with a high accuracy, error mitigation methods can be employed. Since the depth of U_{Q} is smaller than the original circuit U=U_{C}U_{Q}, the method disclosed by various embodiments herein can also decreases the cost of the error mitigation. After running quantum experiments, the expectation values of Pᵢ can be post processed to estimate the expectation value of O′ on a classical computer using the relation Tr(O′U_{Q}|Ψ [symbol] [symbol] Ψ|U_{Q}^{†})=ΣᵢβᵢTr(PᵢU_{Q}|Ψ [symbol] [symbol] Ψ|U_{Q}^{†}), which is equivalent to the original problem of estimating Tr(OU|Ψ [symbol] [symbol] Ψ|U^{†}). Since the expectation value of Pᵢ for each i can be measured, the overall sampling cost can increase by a factor proportional to (Σᵢ|βᵢ|)². However, the reduction in the error mitigation cost can outweigh the increase in the sampling cost due to measuring O′. Thus, by combining classical and quantum resources, various embodiments herein can reduce the depth of a quantum simulation to be run on a quantum computer for reliably estimating expectation values of observables as compared to existing techniques that can be implemented on noisy quantum computers. Performing state propagation on the quantum computer and observable backpropagation on the classical computer can improve the overall accuracy of results generated by executing a quantum circuit by reducing noise in near-term quantum devices.

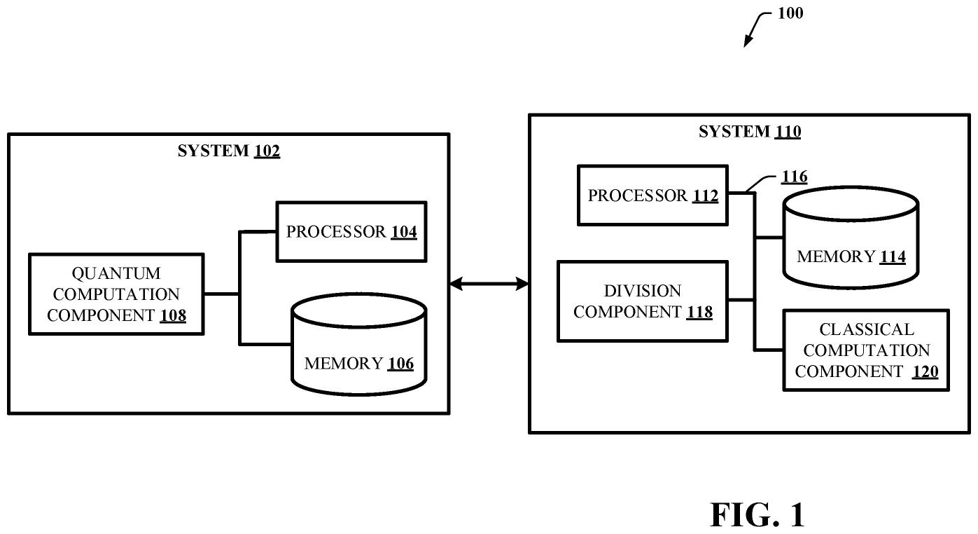

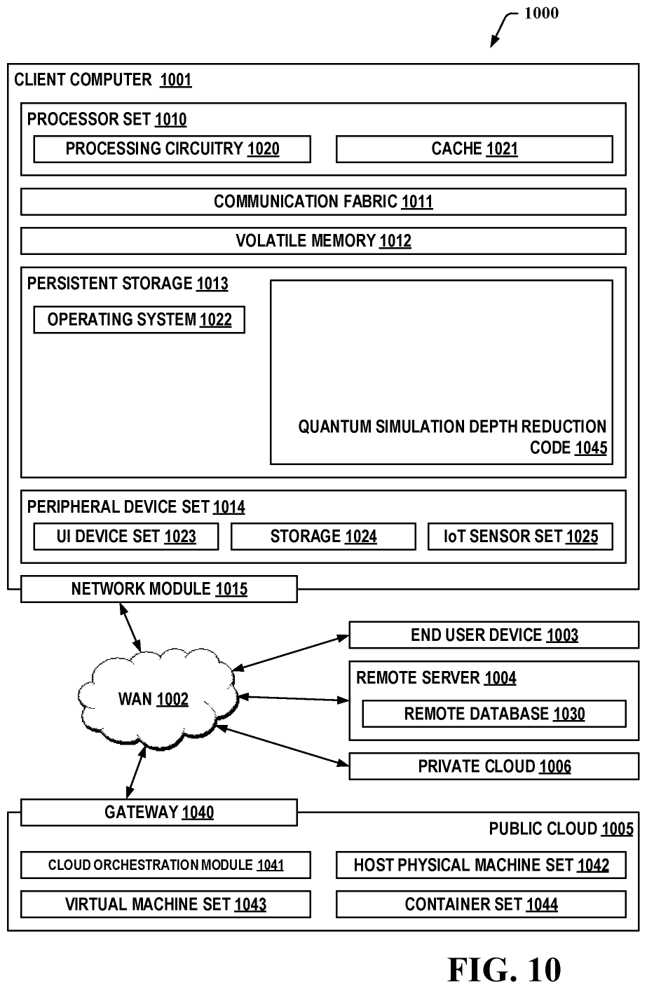

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, system 100 can be associated with, such as accessible via, a computing environment 1000 described below with reference to FIG. 10, such that aspects of processing can be distributed between system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can employ observable backpropagation for improving the depth of a quantum simulation in accordance with one or more embodiments described herein.

The system 100 and/or the components of the system 100 can be employed to use hardware and/or software to solve problems that are highly technical in nature (e.g., related to quantum computing, quantum simulation depths, observable backpropagation, etc.), that are not abstract and that cannot be performed as a set of mental acts by a human. Further, some of the processes performed may be performed by specialized computers for carrying out defined tasks related to employing observable backpropagation for improving the depth of a quantum simulation. The system 100 and/or components of system 100 can be employed to solve new problems that arise through advancements in technologies mentioned above, computer architecture, and/or the like. The system 100 can provide technical improvements to quantum computing systems by reducing a depth of a quantum simulation and reducing a probabilistic error correction (PEC) sampling cost associated with a quantum computation. The PEC sampling cost can result from an attempt to simulate a noiseless outcome upon execution of a quantum circuit. As discussed elsewhere herein, increasing the number of gates in a quantum circuit can increase the depth and noise associated with quantum computations, and after a certain point, a quantum circuit can become entirely noisy. That is, there can be a threshold point beyond which extracting useful information by executing a quantum circuit can be challenging. Embodiments discussed herein can divide a quantum circuit in two parts such that a relatively shorter depth of the quantum circuit can be executed on a quantum computer to prevent computations from reaching the threshold point. Further, another part of the quantum circuit can be executed on a high-performance classical computer to push the capabilities of near-term quantum devices. For example, if a 100-depth quantum circuit can be executed on a quantum computer, embodiments discussed herein can allow a 20-depth quantum circuit to be additionally executed on the high-performance classical computer to execute an overall quantum circuit having a depth of 120. Further, numerical experiments executed in this regard indicated reduction of a few orders of magnitude in a cost of estimating observable expectation values using error mitigation on noisy quantum devices. System 100 can provide additional improvements in terms of attaining a higher accuracy for quantum experiments. For example, in quantum computing expectation values of observables can be measured up to an error, and embodiments discussed herein can produce a smaller error as compared to other methods (e.g., an accuracy of 0.95 versus an accuracy of 0.9). In general, embodiments described herein can combine quantum and classical resources to improve the depth of a quantum simulation on near-term quantum devices.

Discussion turns briefly to processor 104 and memory 106 of system 102. wherein system 102 can be a quantum computer. For example, in one or more embodiments, system 102 can comprise processor 104 (e.g., a quantum processing unit (QPU)). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s). In one or more embodiments, system 102 can comprise a computer-readable memory (e.g., memory 106) that can be operably connected to processor 104. Memory 106 can store computer-executable instructions that, upon execution by processor 104, can cause processor 104 and/or one or more other components of system 102 (e.g., quantum computation component 108 and/or measurement component 202) to perform one or more actions. In one or more embodiments, memory 106 can store the computer-executable components (e.g., quantum computation component 108 and/or measurement component 202).

Discussion turns next to processor 112, memory 114 and bus 116 of system 110, wherein system 110 can be a high-performance classical computer. For example, in one or more embodiments, the system 110 can comprise processor 112 (e.g., computer processing unit, microprocessor, classical processor, and/or like processor). In one or more embodiments, a component associated with system 110, as described herein with or without reference to the one or more figures of the one or more embodiments, can comprise one or more computer and/or machine readable, writable and/or executable components and/or instructions that can be executed by processor 112 to enable performance of one or more processes defined by such component(s) and/or instruction(s). In one or more embodiments, system 110 can comprise a computer-readable memory (e.g., memory 114) that can be operably connected to the processor 112. Memory 114 can store computer-executable instructions that, upon execution by processor 112, can cause processor 112 and/or one or more other components of system 110 (e.g., division component 118, classical computation component 120, and/or post processing component 302) to perform one or more actions. In one or more embodiments, memory 114 can store computer-executable components (e.g., division component 118, classical computation component 120, and/or post processing component 302).

System 110 and/or a component thereof as described herein, can be communicatively, electrically, operatively, optically and/or otherwise coupled to one another via bus 116. Bus 116 can comprise one or more of a memory bus, memory controller, peripheral bus, external bus, local bus, and/or another type of bus that can employ one or more bus architectures. One or more of these examples of bus 116 can be employed. In one or more embodiments, system 110 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 110 can reside in the cloud, and/or can reside locally in a local computing environment (e.g., at a specified location(s)).

System 100 can comprise one or more computer and/or machine readable, writable and/or executable components and/or instructions that, when executed by processor 104 and/or processor 112, can enable performance of one or more operations defined by such component(s) and/or instruction(s). For example, in various embodiments, division component 118 can divide a quantum circuit into a first part and a second part. For example, division component 118 can decompose a quantum circuit U into two parts, U_{Q} and U_{C}, such that U=U_{C}U_{Q}, wherein U_{C} can be executed on a high-performance classical computer (e.g., system 110) and U_{Q} can be executed on a quantum computer (e.g., system 102) to reduce the depth of the corresponding quantum simulation. Division component 118 can employ an algorithm selected by a user to divide U into U_{Q} and U_{C}. Herein, U can represent a unitary. Since near-term quantum computers can be limited by depth due to hardware noise, U_{Q} can be chosen (e.g., by division component 118) such that observable expectation values can be estimated with a high accuracy. In quantum computing, executing operations on a quantum computer can involve the application of quantum gates on qubits, and qubits can often be connected by two-qubit quantum gates in a quantum circuit. In this regard, a depth of a simulation can be defined as gates that can be applied in parallel, at once. For example, a 100-depth circuit can refer to 100 layers of quantum gates, wherein each layer can be made of quantum gates that can be applied in parallel. For example, in a quantum system with 6 qubits, q1, q2, q3, q4, q5 and q6, qubits q1 and q2 can be connected by a two-qubit gate, qubits q3 and q4 can be connected by a two-qubit gate, and qubits q5 and q6 can be connected by a two-qubit gate, at the same time. In other words, qubits q1 and q2, qubits q3 and q4 and qubits q5 and q6 can be connected in parallel to form a layer (e.g., a first layer) of a quantum circuit. The layer of the two-qubit gates connecting each pair of quantum gates (e.g., q1 and q2, q3 and q4, q5 and q6) can represent a single depth of the quantum circuit or a single depth circuit. Further, qubits q2 and q3 can be connected and qubits q4 and q5 can be connected through respective two-qubit gates in a second layer of the quantum circuit due to each of qubits q2, q3, q4 and q5 being connected to other qubits in the first layer, and the second layer can represent the second depth of the quantum circuit. Thus, different layers of parallel quantum gates can be formed. The depth of a quantum simulation can be a metric for measuring the complexity of the quantum circuit, although other metrics can be used to measure the complexity of a quantum circuit.

In various embodiments, quantum computation component 108 can apply state propagation to a first part of the quantum circuit (U_{Q}), on a quantum computer (e.g., system 102), and classical computation component 120 can apply observable backpropagation to a second part of the quantum circuit, on a high-performance classical computer (e.g., system 110). State propagation can be an action of applying a quantum circuit to a quantum state (e.g., an initial quantum state). Observable backpropagation, or Heisenberg-picture simulation, can be a formalism wherein the quantum circuit can be applied to an observable instead of applying the quantum circuit to a quantum state. In various embodiments, applying the state propagation can comprise preparing a quantum state (e.g., a new quantum state) corresponding to the first part of the quantum circuit, and applying the observable backpropagation can comprise computing an effective observable evolved under the second part of the quantum circuit. For example, classical computation component 120 can estimate an evolution of an observable O with respect to U_{C}^{†}, that is, U_{C}^{†}OU_{C}, on the high-performance classical computer (e.g., system 110), wherein assuming O=ΣᵢαᵢPᵢ, classical computation component 120 can compute U_{C}^{†}PᵢU_{C} for each i and determine the effective observable, O′≡U_{C}OU_{C}=ΣᵢβᵢPᵢ, where βᵢ represent the updated coefficients. For an efficient implementation of the embodiments disclosed herein, classical computation component 120 can discard terms in O′ corresponding to βᵢ below a threshold to account for the total error allowed in estimating the observable expectation, Tr(OU|Ψ [symbol] [symbol] Ψ|U^{†}). Thereafter, quantum experiments can be run on the quantum computer (e.g., system 102) to estimate Tr(O′U_{Q}|Ψ [symbol] [symbol] Ψ|U_{Q}^{†}). For example, as part of the quantum experiments, quantum computation component 108 can prepare a state U_{Q}|Ψ [symbol] . Preparation of the state can be followed by measurement of the expectation value [symbol] =Tr(PᵢU_{Q}|Ψ [symbol] [symbol] Ψ|U_{Q}^{†}) by measurement component 202, where Pᵢ corresponds to O′=ΣᵢβᵢPᵢ. Additional aspects of the measurement of the expectation value are disclosed with reference to subsequent figures.

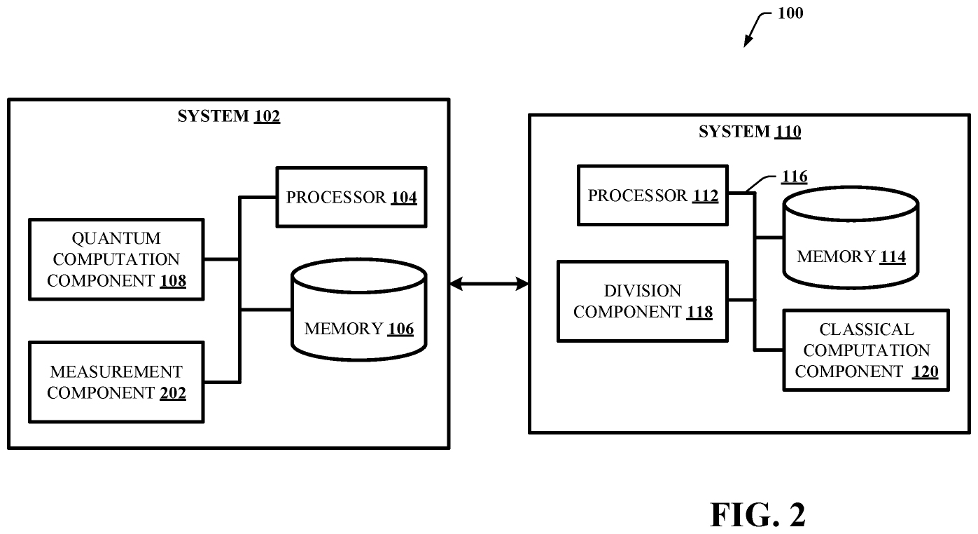

FIG. 2 illustrates a block diagram of the example, non-limiting system 100, wherein system 100 can measure an effective observable with respect to a quantum state for improving the depth of a quantum simulation in accordance with one or more embodiments described herein. Repetitive description of like elements and/or processes employed in respective embodiments is omitted for sake of brevity.

With continued reference to FIG. 1, system 102 can additionally comprise measurement component 202. In various embodiments, measurement component 202 can measure the effective observable (O′) with respect to the quantum state U_{Q}|Ψ [symbol] corresponding to the first part of the quantum circuit to generate an outcome. [symbol] =Tr(PᵢU_{Q}|Ψ [symbol] [symbol] Ψ|U_{Q}^{†}), the expectation value. To estimate the expectation value with a high accuracy, measurement component 202 can employ error mitigation. Since the depth of U_{Q} can be smaller than the original circuit U=U_{C}U_{Q}, the method disclosed by various embodiments herein can also decrease a cost of the error mitigation, additional details of which are disclosed with reference to subsequent figures.

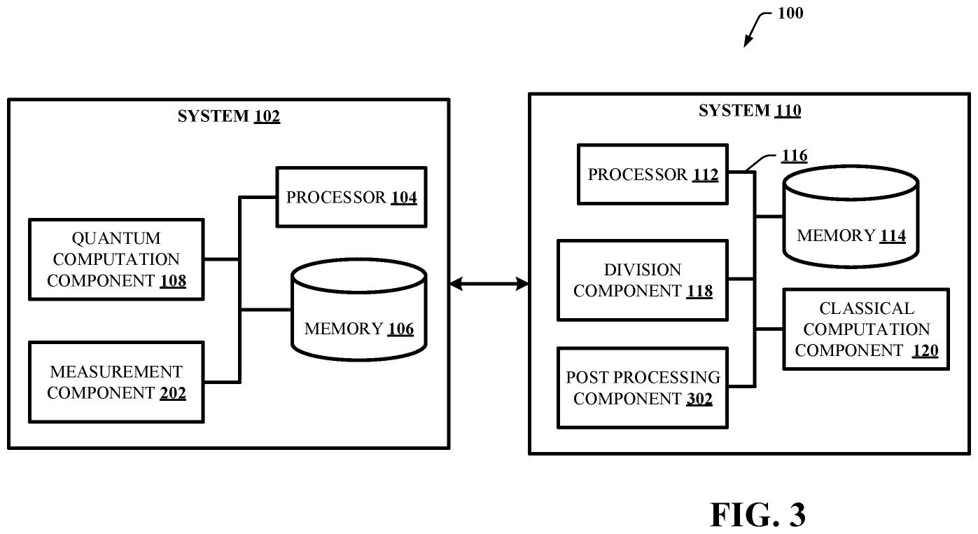

FIG. 3 illustrates a block diagram of the example, non-limiting system 100, wherein system 100 can obtain an observable expectation value for a quantum circuit for improving the depth of a quantum simulation in accordance with one or more embodiments described herein. Repetitive description of like elements and/or processes employed in respective embodiments is omitted for sake of brevity.

With continued reference to FIG. 2, system 110 can additionally comprise post processing component 302. In various embodiments, post processing component 302 can process the outcome (Tr(PᵢU_{Q}|Ψ [symbol] [symbol] Ψ|U_{Q}^{†})) to obtain an observable expectation value for the quantum circuit. For example, after running quantum experiments on the quantum computer (e.g., system 102), post processing component 302 can process the expectation values of Pᵢ on the high-performance classical computer (e.g., system 110) to estimate the expectation value of O′ using the relation Tr(O′U_{Q}|Ψ [symbol] [symbol] Ψ|U_{Q}^{†})=ΣᵢβᵢTr(PᵢU_{Q}|Ψ [symbol] [symbol] Ψ″U_{Q}^{†}), which can be equivalent to the original problem of estimating Tr(OU|Ψ [symbol] [symbol] Ψ|U^{†}). Since the expectation value of Pᵢ for each i can be measured, the overall sampling cost can increase by a factor proportional to (Σᵢ|βᵢ|)². However, the reduction in the error mitigation cost can outweigh the increase in the sampling cost due to measuring O′. In various embodiments, applying the state propagation to the first part of the quantum circuit and the observable backpropagation to the second part of the quantum circuit can increase an effective depth of the quantum circuit. For example, by combining classical and quantum resources, various embodiments herein can increase an effective depth of a quantum circuit and reduce the depth of a quantum simulation corresponding to the quantum circuit for reliably estimating expectation values of observables.

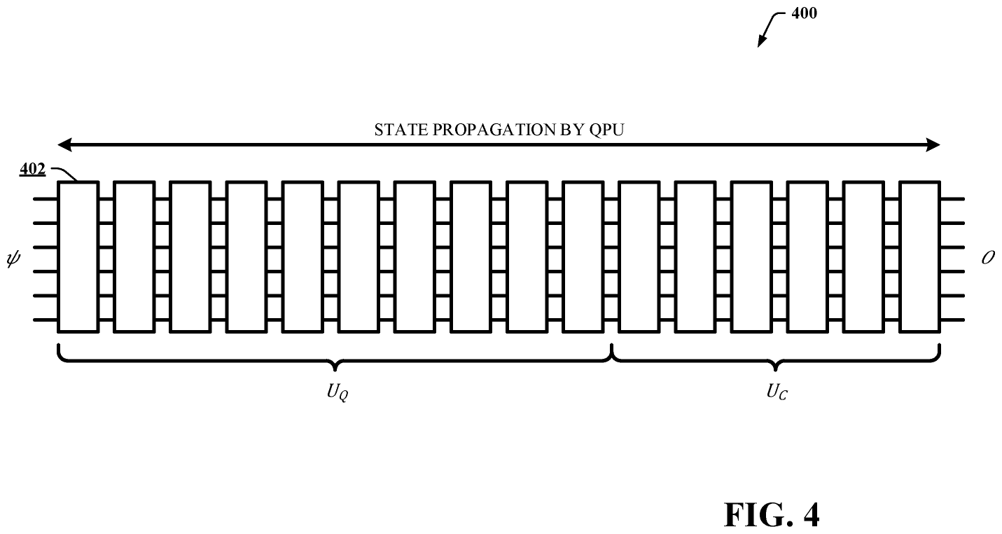

FIG. 4 illustrates a diagram of an example, non-limiting quantum circuit 400 that can be divided into two parts for improving the depth of a quantum simulation in accordance with one or more embodiments described herein. One or more embodiments discussed with reference to FIG. 4 can be enabled by one or more components of system 100. Repetitive description of like elements and/or processes employed in respective embodiments is omitted for sake of brevity.

Quantum simulations can involve applying a quantum circuit on an initial quantum state to measure an observable. Given classical descriptions of a quantum state, a quantum circuit, and an observable, a quantum simulation can be aimed at estimating an expectation value of an observable with respect to a state evolved under the quantum circuit. Various embodiments herein can combine state propagation and observable backpropagation by applying quantum simulations on an initial state (e.g., |Ψ [symbol] ) and evolving an observable, O, to improve a depth of a quantum simulation. State propagation can refer to an action of applying a quantum circuit to a quantum state (e.g., an initial quantum state), and observable backpropagation, or Heisenberg-picture simulation, can be a formalism wherein the quantum circuit can be applied to an observable instead of applying the quantum circuit a quantum state. For example, quantum circuit 400 can be a 100-depth quantum circuit, U, that can be divided (e.g., by division component 118) into an 80-depth quantum circuit, U_{Q}, that can be executed (e.g., by quantum computation component 108) on a quantum computer (e.g., system 102) for an initial quantum state and a 20-depth quantum circuit, U_{C}, that can be executed (e.g., by classical computation component 120) on a high-performance classical computer (e.g., system 110) for estimating an expectation value of O (e.g., measuring O with respect to the state U_{C}U_{Q}|Ψ [symbol] ). Block 402 can represent one layer of parallel quantum gates of quantum circuit 400. As stated elsewhere herein, executing U_{Q} on the quantum computer can comprise applying state propagation to the quantum circuit to generate a quantum state, and executing U_{C} on the high-performance classical computer can comprise applying observable backpropagation to U_{C}.

Applying the state propagation using U_{Q}, can generate a quantum state, U_{Q}|Ψ [symbol] . Applying the backpropagation using U_{C} can determine how a final observable can change because of an effect of U_{C}. In other words, executing U_{C} on the high-performance classical computer can determine the inverse evolution or backpropagation of the observable (i.e., observable backpropagation), resulting in an effective observable or a modified observable, O′. The modified observable can be measured with respect to the quantum state, U_{Q}|Ψ [symbol] . corresponding to U_{Q} to generate an expectation value, [symbol] =Tr(PᵢU_{Q}|Ψ [symbol] [symbol] Ψ|U_{Q}^{†}). Quantum circuit, U, can be a deep quantum circuit and executing U without dividing U into U_{Q} and U_{C} can involve computation capabilities beyond those provided by existing QPUs. Thus, executing one part of the quantum circuit on a quantum computer and another part of the quantum circuit on a high-performance classical computer followed by combining the results can allow a bigger problem to be solved using a combination of quantum computing and classical computing.

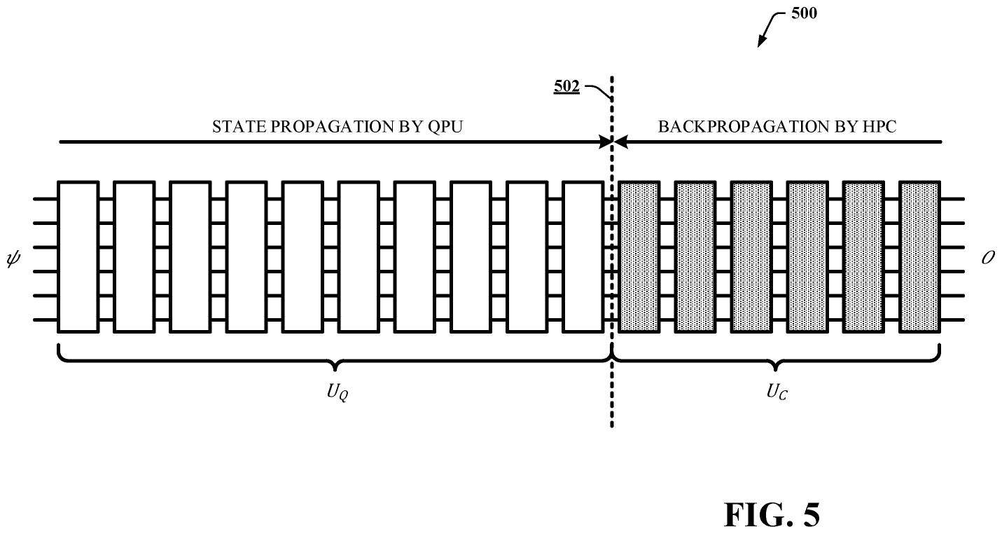

FIG. 5 illustrates a diagram of an example, non-limiting quantum circuit 500 divided into two parts for improving the depth of a quantum simulation in accordance with one or more embodiments described herein. One or more embodiments discussed with reference to FIG. 5 can be enabled by one or more components of system 100. Repetitive description of like elements and/or processes employed in respective embodiments is omitted for sake of brevity.

With continued reference to at least FIG. 4, quantum circuit 500 can be a quantum circuit, U, divided into two portions, U_{Q} and U_{C}, as indicated by imaginary line 502, such that U=U_{C}U_{Q}. Quantum circuit 500 can be generated to estimate an expectation value Tr(OU_{c}U_{Q}|Ψ [symbol] [symbol] Ψ|U_{Q}^{†}U_{C}^{†}) of an observable O. As stated elsewhere herein, division of the quantum circuit can be performed classically/on a classical computer, wherein an entity (e.g., a software, a hardware, a machine, artificial intelligence (AI) or a human user) can select an algorithm that can be implemented by division component 118 on a classical computer (e.g., system 110). Dividing the quantum circuit can allow quantum and classical resources to be combined for improving the depth of a quantum simulation on a near-term quantum device. For example, by dividing a 120-depth quantum circuit into a 100-depth quantum circuit (U_{Q}) that can be run on the quantum computer and a 20-depth quantum circuit (U_{C}) that can be run on a high performance computer (HPC), the 120-depth quantum circuit can be executed to solve a problem using a quantum computer (e.g., system 102) having a capacity to run a 100-depth quantum circuit.

In various embodiments, U_{C} can be executed (e.g., by classical computation component 120) on a high-performance classical computer (e.g., system 110) through observable backpropagation to determine an effective observable or modified observable, O′, to be measured on a quantum device (e.g., system 102). Thereafter, O′ and U_{Q} can be sent to the quantum device for further computations, wherein the quantum device can generate the quantum state, U_{Q}|Ψ [symbol] , by executing U_{Q}, and measure O with respect to U_{Q}|Ψ [symbol] . More specifically, classical computation component 120 can measure O to determine the modified observable, O′, at the position indicated by imaginary line 502, as an effect of executing U_{C}. The observable, O, can be a Pauli Z, wherein O=ΣᵢPᵢ, however, when evolved under U_{C}, O can become a combination of different Paulis, resulting in O′, wherein O′≡U_{C}^{†}OU_{C}=ΣᵢβᵢPᵢ. Stated differently, O (O=ΣᵢαᵢPᵢ) can be modified to O′ (O′≡U_{C}^{†}OU_{C}=ΣᵢβᵢPᵢ) using U_{C}. Herein, Pᵢ can represent a Pauli matrix, αᵢ can be a coefficient or constant, and αᵢPᵢ can represent a linear combination of different Pauli matrices. Similarly, βᵢ can be a coefficient or constant, and Bi Pi can represent a linear combination of different Pauli matrices. Thus, measuring (e.g., by measurement component 202) O′ on the quantum device can comprise performing computations for different Paulis, Pᵢ. The various embodiments herein can be used to solve different problems such as, for example, optimization problems using a Quantum Approximate Optimization Algorithm (QAOA) or another algorithm, etc. Further, the various embodiments discussed herein can be applied to different quantum circuits without being limited to, for example, a variational quantum circuit. As such, different problems can have a different U, and, therefore, different U_{Q} and U_{C}. In general, U_{C} can represent two-qubit gates acting on different pairs of qubits, and changing the gates can also change the effective observable as an effect of executing U_{C} on the high-performance classical computer.

U_{C} can be executed on the high-performance classical computer because U_{C} can be a small depth circuit. In general, a very deep circuit can have an exponential cost, preventing such a circuit from being run on a classical computer, but a short depth circuit can be run on the high-performance quantum computer. Further, U_{C} can be executed using fully classical approaches. In one or more embodiments, classical simulators for quantum hardware can be used to execute U_{C} and determine O′. On the quantum device, O′=U_{C}^{†}OU_{C} can be measured with respect to the state U_{Q}|Ψ [symbol] to compute an expectation value. As stated above, U_{C}^{†}OU_{C}=ΣᵢβᵢPᵢ, wherein βᵢPᵢ can represent a linear combination of different Pauli matrices and measuring O′ with respect to the state U_{Q}|Ψ [symbol] ) on the quantum device can imply measuring a trace (Tr) for each of the Paulis, wherein the operation can be represented as [symbol] =Tr(PᵢU_{Q}|Ψ [symbol] [symbol] Ψ|U_{Q}^{†}). Upon measuring a trace for each Pauli, an expectation value of O can be computed (e.g., by post processing component 302) on the high-performance classical computer. For example, post processing component 302 can post process [symbol] to estimate Tr(OU_{c}U_{Q}|Ψ [symbol] [symbol] Ψ|U_{Q}^{†}U_{C}^{†})=Σᵢβᵢ [symbol] using the relation Tr(O′U_{Q}|Ψ [symbol] [symbol] Ψ|U_{Q}^{†})=ΣᵢβᵢTr(PᵢU_{Q}|Ψ [symbol] [symbol] |U_{Q}^{†}), which can be equivalent to the original problem of estimating Tr(OU|Ψ [symbol] [symbol] Ψ|U^{†}). As described above, O′ can be a sum of different Paulis, and the quantum device can generate an expectation value for each Pauli. During post processing, post processing component 302 can sum the Paulis with a proper weight in front of them to generate the expected value for the observable O, and post processing component 302 can employ an algorithm to perform the summation of the Paulis.

Since the expectation value of Pᵢ for each i can be measured, an overall sampling cost associated with the measurements can increase by a factor proportional to (Σᵢ|βᵢ|)². However, a reduction in the error mitigation cost associated with error mitigation methods employed (e.g., by measurement component 202) to estimate the expectation value of O′ can outweigh the increase in the sampling cost due to measuring O′. In this regard, numerical experiments were performed to demonstrate a comparison of the overall sampling cost and the error mitigation cost in accordance with various embodiments herein. For example, in a scenario, quantum circuit U can be a circuit having n number of qubits and depth d, wherein n=127 and d=64. Additionally, an error probability per qubit depth can be ϵ=0.002 for U. As stated elsewhere herein, the depth of a quantum circuit can represent the number of layers of parallel gates, and ϵ can represent the noise or the noise rate at each depth. Since n=127, U can be executed on a quantum device having 127 qubits, however, executing U entirely on a quantum computer using only state propagation (e.g., contrary to the method disclosed by the various embodiments herein) can result in a PEC sampling cost. The PEC sampling cost can result from an attempt to simulate a noiseless outcome upon execution of U. For example, an effect of noise in U can be removed, however, the procedure to remove the noise can have a cost associated with it, wherein the cost can be known as the PEC sampling cost. The PEC sampling cost can be given by γ²˜(1+4ϵ)^{nd}, wherein γ can quantify the number of experiments needed to be run on a quantum computer to mitigate the noise, for a given noise rate, ϵ.

For n=127, d=64 and ϵ=0.002, the PEC sampling cost can be γ²˜(1+4ϵ)^{nd}˜1.3×10²⁸, for the scenario where U can be entirely run on a quantum computer. On the contrary, assuming U to be a 64-depth quantum circuit, various embodiments herein can allow U to be divided (e.g., by division component 118) into a 48-depth quantum circuit (U_{Q}) and a 16-depth quantum circuit (U_{C}), wherein the 48-depth quantum circuit can be executed on a quantum computer (e.g., system 102) through state propagation and the 16-depth quantum circuit can be executed on a high-performance classical computer (e.g., system 110) through observable backpropagation. In this case, due to the state propagation depth d_{Q} being 48 and the observable backpropagation depth d_{C} being 16, the PEC sampling cost can be γ²˜(1+4ϵ)^{nd}^{_{Q}}˜1.2×10²¹. That is, running only a portion of U on the quantum computer instead of running U entirely on the quantum computer, can generate a smaller PEC sampling cost (i.e., 10²¹ instead of 10²⁸, a reduction of ˜10⁷ in PEC sampling cost). As stated above, because a quantum circuit can have noise, experiments need to be performed to remove an adverse effect of the noise, and the number of experiments needed to be performed for a quantum circuit can determine the PEC sampling cost.

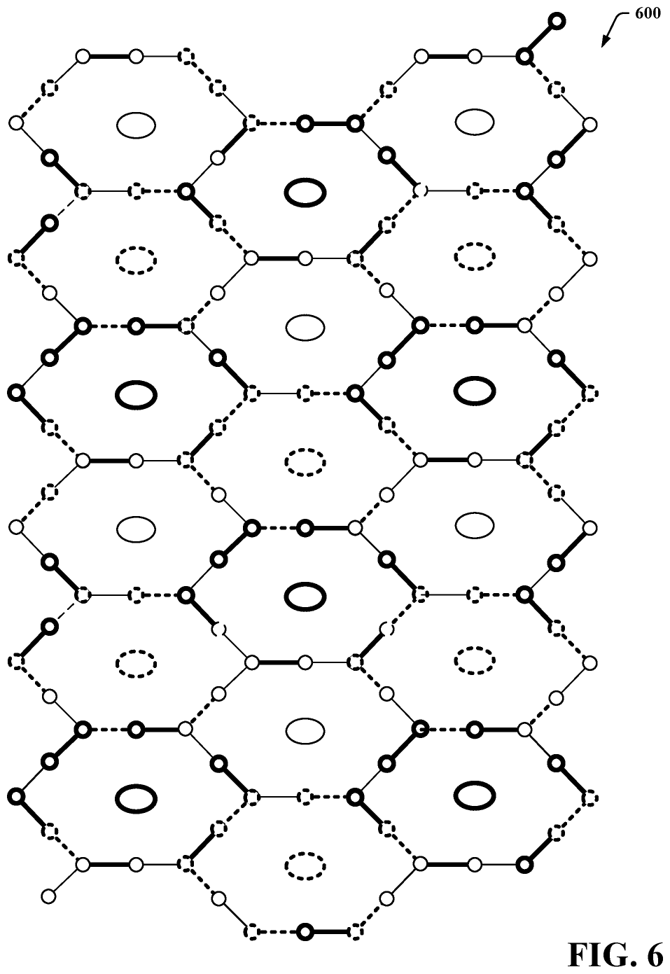

FIG. 6 illustrates a diagram of an example, non-limiting heavy hex lattice 600 showing a kicked Ising model in accordance with one or more embodiments described herein. One or more embodiments discussed with reference to FIG. 6 can be enabled by one or more components of system 100. Repetitive description of like elements and/or processes employed in respective embodiments is omitted for sake of brevity.

With continued reference to FIG. 5, the embodiments discussed herein can be applied to various quantum simulations. One example of such a quantum simulation can be a Hamiltonian simulation. A Hamiltonian simulation can involve a classical-quantum algorithm for simulation of the dynamics of a quantum state and a manner of evolution of a quantum state under a Hamiltonian (H). Simulating the evolution of a quantum state can comprise measuring an observable in the time evolved quantum state. Simulating the evolution of a quantum state can be achieved by evolving the quantum state for small time-steps. For example, for evolving a quantum state for 10 time-steps, the quantum state can usually be evolved for time-step 1, time-step 1 and time-step 1. Applying the various embodiments discussed herein for a Hamiltonian simulation can involve dividing a quantum circuit such that the first seven time-steps can be simulated on a quantum device (e.g., system 102) and the last three time-steps can be simulated on a classical device (e.g., system 110). Time evolution with respect to H can imply applying an exponential of negative (−)Ĥt (i.e., e^{-iĤt}). The exponential can be broken down in terms of gates, because H can be described and known classically.

Illustrated in FIG. 6 is a kicked Ising model on heavy hex lattice 600. Different lines (the thin solid line, the thick solid line, and the thick dashed line) can correspond to different types of nodes and edges of heavy hex lattice 600. An Ising model has two terms, wherein the first term can be the sum of ZZ or XX. The sum of the ZZ or the XX on the side of nearest neighbors on heavy hex lattice 600 can be represented as H_{R}^{(ZZ)}=Σ_{(i,j)∈R}ZᵢZⱼ, H_{G}^{(ZZ)}=Σ_{(i,j)∈G}ZᵢZⱼ, H_{B}^{(ZZ)}=Σ_{(i,j)∈B}ZᵢZⱼ, wherein all three terms can be the first term in the Ising model. The second term in the Ising model can be the sum of the local magnetic field given by H^{(X)}=ΣᵢX_{i,}which represents the sum of only a single side Pauli Z. H^{(X)} can be a Hamiltonian that can depend on Pauli X. A kicked Ising model can be the quantum circuit, U, that can be executed to solve a problem. In this context, compilation can be defined as an attempt to decompose the time evolution of the quantum state, that is, to decompose the unitaries that can represent the ideal evolution of a quantum state into a series of quantum gates. In various embodiments herein, U can represent the series of quantum gates, and, thus, the kicked Ising model can be the entire U. U can be represented as U=W_{L}=W^{L}^{_{C}}W^{L}^{_{Q}}=U_{C}U_{Q}, wherein W^{L} can be W run for L times. U can be divided (e.g., by division component 118) into a first part, W^{L}^{_{Q}}, that can be executed (e.g., by quantum computation component 108) on a quantum computer, and a second part, W^{L}^{_{C}}, that can be executed (e.g., by classical computation component 120) on a high-performance classical computer. W^{L}^{_{Q}} can represent W run for L_{Q} times, and W^{L}^{_{C}} can represent W run for L_{C} times. W can be defined by the relation in equation 1, which can identify different blocks of time evolved.

$$W = {e}^{- {iH}_{R}^{( ZZ )} {θ}_{J}} \cdot {e}^{- {iH}_{B}^{( ZZ )} {θ}_{J}} \cdot {e}^{- {iH}_{G}^{( ZZ )} {θ}_{J}} \cdot {e}^{- {iH}^{( X )} {θ}_{h}} , \qquad Equation 1$$

wherein H_{R}^{(ZZ)}=Σ_{(i,j)∈R}ZᵢZⱼ, H_{G}^{(ZZ)}=Σ_{(i,j)∈G}ZᵢZⱼ, H_{B}^{(ZZ)}=Σ_{(i,j)∈B}ZᵢZⱼ, H^{(X)=Σ}ᵢXᵢ, θ_{J}=Jδt=0.1, and θₕ=hδt=0.1. Further, in the given scenario, the number of qubits, n=127 and the observable, O=Z₁. As stated above, H_{R}^{(ZZ)}=Σ_{(i,j)∈R}ZᵢZⱼ, H_{G}^{(ZZ)}=Σ_{(i,j)∈G}ZᵢZⱼ, and H_{B}^{(ZZ)}=Σ_{(i,j)∈B}ZᵢZⱼ can be the first term in the Ising model, and H^{(Z)}=ΣᵢZᵢ can be the second term in the Ising model.

W can involve rotations in different terms. For example, there can be different rotations around Hamiltonians, such as H_{R}, H_{B}, H_{G}, etc. Such rotations, once in the Pauli matrix format, can be broken into two-qubit gates on a quantum computer. Thus, W can be a rotation under H^{(X)} on angle θₕ followed by a rotation under H^{(ZZ)} on angle θⱼ.

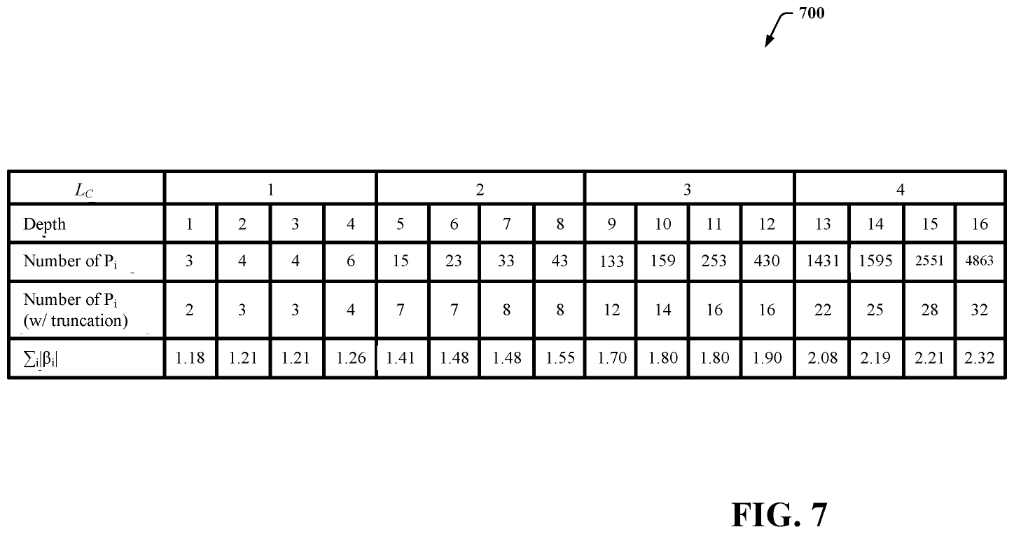

FIG. 7 illustrates a diagram of an example, non-limiting table 700 showing a comparison of an overall sampling cost and an error mitigation cost for a quantum simulation in accordance with one or more embodiments described herein. One or more embodiments discussed with reference to FIG. 7 can be enabled by one or more components of system 100. Repetitive description of like elements and/or processes employed in respective embodiments is omitted for sake of brevity.

Table 700 shows a comparison of a reduction in the PEC sampling cost with an increase in a sampling overhead as a result of implementing the various embodiments discussed herein. As discussed with reference to FIG. 5, dividing a quantum circuit, U, into a portion U_{Q} that can be computed (e.g., by quantum computation component 108) on a quantum computer and another portion U_{C} that can be computed (e.g., by classical computation component 120) on a classical computer can allow a PEC sampling cost associated with experiments performed to reduce noise in U (e.g., U_{Q}) to be reduced in comparison to the PEC sampling cost associated with executing U entirely on the quantum computer. However, the reduction in the PEC sampling cost can be at the expense of an increased sampling overhead resulting from measurement of an expectation value for each Pauli (Pᵢ) on the quantum device (e.g., system 102), and the number of Paulis to be measured can be related to (Σᵢ|βᵢ|)², wherein Σᵢ|βᵢ| can represent the sum of the absolute value of coefficients. Thus, the overall sampling cost or overhead can increase by a factor proportional to (Σᵢ|βᵢ|)². With continued reference to FIGS. 5 and 6, table 700 lists the number of Paulis that need to be measured for a value of W between 1 and 4 for a 16-depth quantum circuit, with and without truncation of the quantum circuit. In other words, table 700 shows a sampling overhead resulting from dividing the quantum circuit, U, such that a portion of U can be computed classically (e.g., by classical computation component 120). It can be evident from table 700 that the reduction in the PEC sampling cost can outweigh the increased sampling overhead resulting from measuring different Paulis. For example, for simulating the Ising model, Pᵢ: (Σᵢ|βᵢ|)²˜5.4. Algorithm 1 provided at the end of this section can be used to generate Table 700 showing values related to the backpropagated observables.

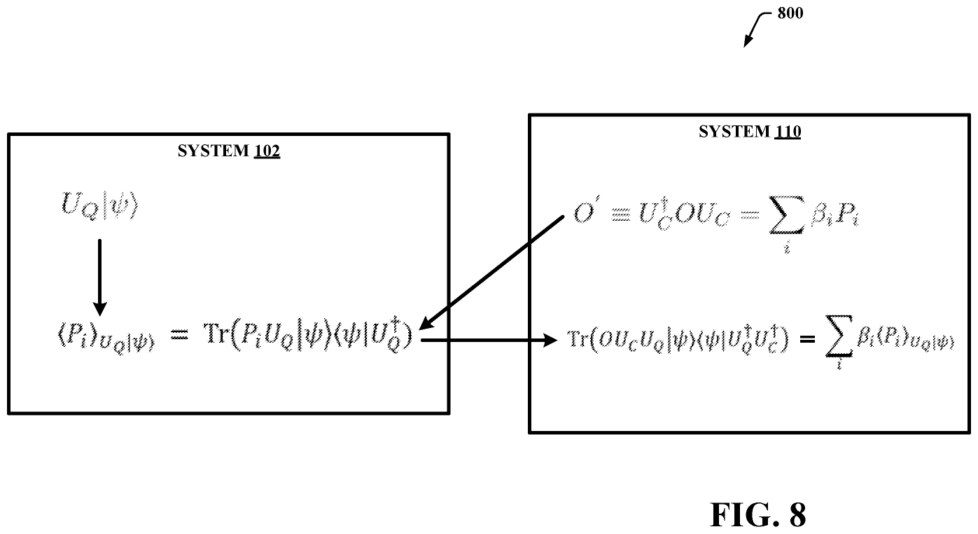

FIG. 8 illustrates a flow diagram of an example, non-limiting process 800 for estimating an observable expectation value in accordance with one or more embodiments described herein. One or more embodiments discussed with reference to FIG. 8 can be enabled by one or more components of system 100. Repetitive description of like elements and/or processes employed in respective embodiments is omitted for sake of brevity.

Process 800 can summarize the various embodiments discussed heretofore. In various embodiments, a quantum circuit, U, can be divided (e.g., by division component 118) on a classical computer (e.g., system 110) into a first part, U_{Q}, and a second part, U_{C}, to estimate the expectation value of an observable O. U_{C} can be executed (e.g., by classical computation component 120) on a high-performance classical computer (e.g., system 110) to generate a modified observable O′ from the observable O by using observable backpropagation, and U_{Q} can be executed (e.g., by quantum computation component 108) on a quantum computer (e.g., system 102) to generate a quantum state U_{Q}|Ψ [symbol] . Thereafter, quantum experiments can be run on the quantum computer to measure (e.g., using measurement component 202) the effective observable O′ with respect to the quantum state U_{Q}|Ψ [symbol] to compute an expectation value, wherein 0′=U_{C}^{†}OU_{C}=ZᵢβᵢPᵢ, and wherein βᵢPᵢ can represent a linear combination of different Pauli matrices. Measuring O′ with respect to the quantum state U_{Q}|Ψ [symbol] on the quantum computer can imply measuring a trace (Tr) for each of the Paulis (Pᵢ), and the operation can be represented by the relation [symbol] =Tr(PᵢU_{Q}|Ψ [symbol] [symbol] Ψ|U_{Q}^{†}). Upon generating of Tr(PᵢU_{Q}|Ψ [symbol] [symbol] Ψ|U_{Q}^{†}), the expectation values of Pᵢ can be computed (e.g., by post processing component 302) on a high-performance classical computer (e.g., system 110) to estimate the expectation value of O′ using the relation Tr(O′U_{Q}|Ψ [symbol] [symbol] Ψ|U_{Q}^{†})=ΣᵢβᵢTr(PᵢU_{Q}|Ψ [symbol] [symbol] Ψ|U_{q}^{†}), which can be equivalent to the original problem of estimating Tr(OU|Ψ [symbol] [symbol] Ψ|U^{†}) (wherein, Tr(OU|Ψ [symbol] [symbol] Ψ|U^{†})=Trj(OU_{C}U_{Q}|Ψ [symbol] [symbol] Ψ|U_{Q}^{†}U_{C}^{†})=Σᵢβᵢ [symbol] ). Since the expectation value of Pᵢ for each i can be measured, an overall sampling cost associated with the measurements can increase by a factor proportional to (Σᵢ|βᵢ|)². However, a reduction in the error mitigation cost associated with error mitigation methods employed (e.g., by measurement component 202) to estimate the expectation value of O′ can outweigh the increase in the sampling cost due to measuring O′.

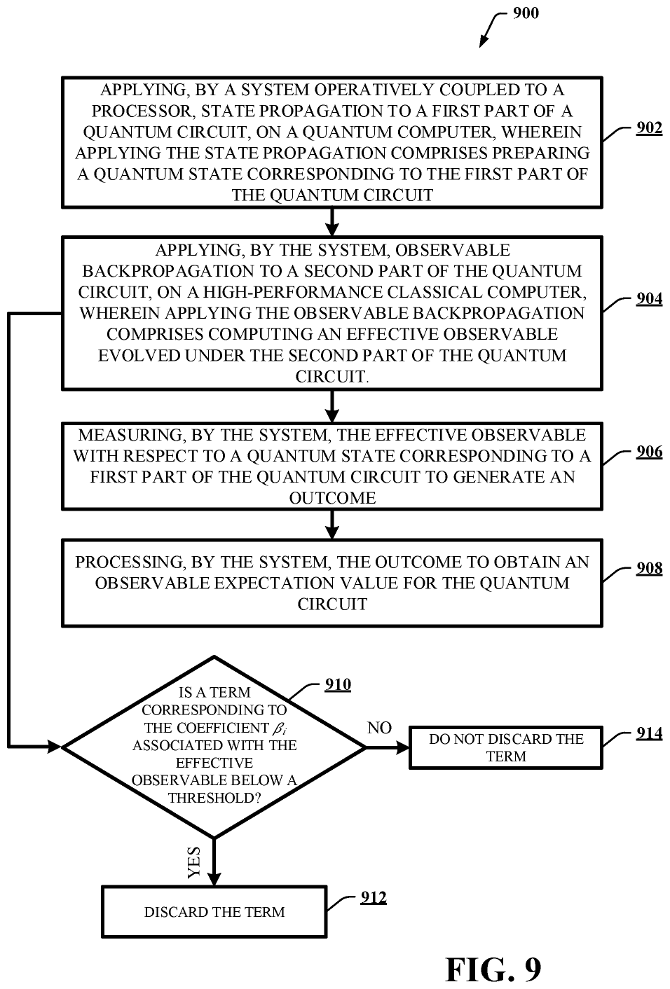

FIG. 9 illustrates a flow diagram of an example, non-limiting method 900 that can employ observable backpropagation for improving the depth of a quantum simulation in accordance with one or more embodiments described herein. One or more embodiments discussed with reference to FIG. 9 can be enabled by one or more components of system 100. Repetitive description of like elements and/or processes employed in respective embodiments is omitted for sake of brevity.

At 902, the non-limiting method 900 can comprise applying (e.g., by a quantum computation component 108), by a system operatively coupled to a processor, state propagation to a first part of a quantum circuit, on a quantum computer, wherein applying the state propagation can comprise preparing a quantum state corresponding to the first part of the quantum circuit.

At 904, the non-limiting method 900 can comprise applying (e.g., by a classical computation component 120), by the system, observable backpropagation to a second part of the quantum circuit, on a high-performance classical computer, wherein applying the observable backpropagation can comprise computing an effective observable evolved under the second part of the quantum circuit.

At 906, the non-limiting method 900 can comprise measuring (e.g., by measurement component 202), by the system, the effective observable with respect to a quantum state corresponding to a first part of the quantum circuit to generate an outcome.

At 908, the non-limiting method 900 can comprise processing (e.g., by post processing component 302), by the system, the outcome to obtain an observable expectation value for the quantum circuit.

At 910, the non-limiting method 900 can comprise determining (e.g., by classical computation component 120), by the system, if a term in the effective observable (O′) corresponding to the coefficient Bᵢ is below a threshold.

If yes, at 912, the non-limiting method 900 can comprise discarding (e.g., by classical computation component 120), by the system, the term.

If no, at 914, the non-limiting method 900 can comprise not discarding the term.

Non-limiting method 900 can be a method for improving the depth of a quantum simulation by dividing a quantum circuit into two parts, using a quantum computer to prepare a quantum state corresponding to a first part of the quantum circuit, using a high-performance classical computer to compute an effective observable evolved under a second part of the quantum circuit, measuring the effective observable with respect to the quantum state prepared using the first part of the quantum circuit, and post processing the measurement outcomes to obtain an observable expectation value for the original quantum circuit.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively evolve an observable using observable backpropagation to generate a modified observable and measure the modified observable with respect to a quantum state as the one or more embodiments described herein can enable this process. And, neither can the human mind nor a human with pen and paper implement state propagation and observable back propagation to reduce the depth of a quantum simulation, as conducted by one or more embodiments described herein.

One or more embodiments described herein can provide a number of advantages, including reducing the depth of a quantum simulation that can be performed on a quantum computer, pushing capabilities of near-term quantum devices for executing deep quantum circuits and reducing a cost of estimating observable expectation values using error mitigation on noisy quantum devices. More specifically, embodiments discussed herein can provide technical improvements to quantum computing systems by reducing a depth of a quantum simulation, reducing a PEC sampling cost associated with a quantum computation, etc. As discussed elsewhere herein, increasing the number of gates in a quantum circuit can increase the depth and noise associated with quantum computations, and after a certain point, a quantum circuit can become entirely noisy. That is, there can be a threshold point beyond which extracting useful information by executing a quantum circuit can be challenging. Embodiments discussed herein can divide a quantum circuit in two parts such that a relatively shorter depth of the quantum circuit can be executed on a quantum computer to prevent computations from reaching the threshold point. Further, another part of the quantum circuit can be executed on a high-performance classical computer to further push the depth of a quantum simulation. For example, if a 100-depth quantum circuit can be executed on a quantum computer, embodiments discussed herein can allow a 20-depth quantum circuit to be executed on the high-performance classical computer for a total of a 120-depth quantum circuit. Further, numerical experiments executed in this regard indicated an improvement of a few orders of magnitude in a PEC sampling cost associated with estimating observable expectation values using error mitigation on noisy quantum devices.

FIG. 10 illustrates a block diagram of an example, non-limiting operating environment 1000 in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as quantum simulation depth reduction code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

Algorithm 1:

import numpy as np
import math
from qiskit.quantum_info import PauliList
import json
class PauliStrings:

def _{——}init_{——}(self,n):

self.n = n # number of qubits
self.coeffs = [0] # coeficients in front of Pauli strings
self.strings = np.zeros((1,n)) # store the Pauli strings

def add_string(self,coeff,string):

c = self.contain(string)
if c == −1:

self.coeffs.append(coeff)
self.strings = np.append(self.strings,[string],axis = 0)

else:

self.coeffs[c] += coeff

def contain(self,string):

# check if string is already in self.strings
if string in self.strings.tolist( ):

return self.strings.tolist( ).index(string)

else:

return −1

def propagate(self,circuit,gate):

# propagate the list of Pauli strings through a layer
strings = self.strings[:]
coeffs = self.coeffs[:]
S = strings.shape[0]
for s in range(1,S):

string = strings[s]
coeff = coeffs[s]
after_layer = circuit.propagate(string.tolist( ),gate) # each layer must

have a function to propagate a string

if after_layer.strings.shape[0] > 1:

self.add_string(-coeff,string.tolist( )) # temporarily remove the

string in question

# loop over the new strings generated by the layer
for i in range(1,after_layer.strings.shape[0]):

new_coeff = after_layer.coeffs[i]*coeff
new_string = after_layer.strings[i].tolist( )
self.add_string(new_coeff,new_string)

def chop(self,threshold = 0.01):

# count the number of coeffs greater than some values
count = 0
coeffs = np.sort(np.abs(self.coeffs[:]))
for c in coeffs:

if c < threshold:

count += 1
threshold −= c

return coeffs.shape[0]-count

def truncate(self,threshold = 0.01):

clist = self.coeffs[:]
clist_sorted = sorted(clist, key = abs)
truncated_list = [ ]
for c in clist_sorted:

if np.abs(c) < threshold:

threshold −= np.abs(c)
c_index = clist.index(c)
truncated_list.append(c_index)
clist[c_index] = −1000

remained_list = list(set(range(len(clist)))-set(truncated_list))
P_truncated = PauliStrings(self.n)
P_truncated.coeffs = [self.coeffs[i] for i in remained_list]
P_truncated.strings = np.array([self.strings[i] for i in remained_list])
return P_truncated

def print_string(self,string):

letters = [‘I’,‘X’,‘Y’,‘Z’]
for k in range(string.shape[0]):

if string[k] > 0:

print(letters[int(string[k])],end = ″)
print(k,end = ‘ ’)

print(″)

def print_string_long(self,string):

letters = [‘I’,‘X’,‘Y’,‘Z’]
s = ″
for k in string:

s = s + letters[int(k)]

# print(s)
return s

def print_strings_long(self):

strings_long = [ ]
for string in self.strings:

s = self.print_string_long(string)
strings_long.append(s)

return strings_long

class Gate( ):

def _{——}init_{——}(self,type,support):

self.type = type
self.support = support

class Ising_Circuit( ):

def _{——}init_{——}(self,n,theta_J,theta_h):

self.n = n
self.theta_J = theta_J
self.theta_h = theta_h

def propagate(self,string,gate):

P = PauliStrings(self.n)
match gate.type:

case “X_rotation”:

c= math.cos(2*self.theta_h)
s= math.sin(2*self.theta_h)
if string[gate.support] == 3: # Pauli Z at the support of the

gate

P.add_string(c,string) # the same string has reduced

weight

string[gate.support] = 2
P.add_string(s,string) # new string with Z --> Y

elif string[gate.support] == 2: # Pauli Y at the support

P.add_string(c,string) # the same string has reduced

weight

string[gate.support] = 3
P.add_string(-s,string) # new string with Z --> Y

case “ZZ_rotation”:

c= math.cos(2*self.theta_J)
s= math.sin(2*self.theta_J)
i = gate.support[0]
j = gate.support[1]
new_string = string[:]
if string[i] == 0:

if string[j] == 1:

P.add_string(c,string) # the same string has

reduced weight

new_string[i] = 3
new_string[j] = 2
P.add_string(-s,new_string)

if string[j] == 2:

P.add_string(c,string) # the same string has

reduced weight

new_string[i] = 3
new_string[j] = 1
P.add_string(s,new_string)

if string[i] == 3:

if string[j] == 1:

| | P.add_string(c,string) # the same string has |
|---|---|
| reduced weight | |
| | new_string[i] = 0 |
| | new_string[j] = 2 |
| | P.add_string(-s,new_string) |

if string[j] == 2:

P.add_string(c,string) # the same string has

reduced weight

new_string[i] = 0
new_string[j] = 1
P.add_string(s,new_string)

if string[i] == 1:

if string[j] == 0:

P.add_string(c,string) # the same string has

reduced weight

new_string[i] = 2
new_string[j] = 3
P.add_string(-s,new_string)

if string[j] == 3:

P.add_string(c, string) # the same string has

reduced weight

new_string[i] = 2
new_string[j] = 0
P.add_string(-s,new_string)

if string[i] == 2:

if string[j] == 0:

P.add_string(c,string) # the same string has

reduced weight

new_string[i] = 1
new_string[j] = 3
P.add_string(s,new_string)

if string[j] == 3:

P.add_string(c, string) # the same string has

reduced weight

new_string[i] = 1
new_string[j] = 0
P.add_string(s,new_string)

# print(“--”)
# print(P.strings)
return P

n = 127
theta_J = 0.1
theta_h = 0.1
Ps = PauliStrings(n)
string = np.zeros(n)
for i in range(1):

string[i] = 3

Ps.add_string(1,string.tolist( ))
circuit = Ising_Circuit(n,theta_J,theta_h)
# print(P.strings)
# print(P.coeffs)
ZZ_layer1 = [[2, 1], [33, 39], [59, 60], [66, 67], [72, 81], [118, 119], [21, 20], [26, 25],
[13, 12], [31, 32], [70, 74], [122, 123], [97, 96], [57, 56], [63, 64], [107, 108], [103,
104], [46, 45], [28, 35], [7, 6], [79, 78], [5, 4], [109, 114], [62, 61], [58, 71], [37, 52],
[76, 77], [0, 14], [36, 51], [106, 105], [73, 85], [88, 87], [68, 55], [116, 115], [94, 95],
[100, 110], [17, 30], [92, 102], [50, 49], [83, 84], [48, 47], [98, 99], [8, 9], [121, 120],
[23, 24], [44, 43], [22, 15], [53, 41]]
ZZ_layer2 = [53, 60], [123, 124], [21, 22], [11, 12], [67, 68], [2, 3], [66, 65], [122,
121], [110, 118], [6, 5], [94, 90], [28, 29], [14, 18], [62, 63], [111, 104], [100, 99], [45,
44], [4, 15], [20, 19], [57, 58], [77, 71], [76, 75], [26, 27], [16, 8], [35, 47], [31, 30], [48,
49], [69, 70], [125, 126], [89, 74], [80, 79], [116, 117], [114, 113], [10, 9], [106, 93],
[101, 102], [92, 83], [98, 91], [82, 81], [54, 64], [96, 109], [85, 84], [87, 86], [108, 112],
[34, 24], [42, 43], [40, 41], [39, 38]]
ZZ_layer3 = [[10, 11], [54, 45], [111, 122], [64, 65], [60, 61], [103, 102], [72, 62], [4,
3], [33, 20], [58, 59], [26, 16], [28, 27], [8, 7], [104, 105], [66, 73], [87, 93], [85, 86],
[55, 49], [68, 69], [89, 88], [80, 81], [117, 118], [101, 100], [114, 115], [96, 95], [29,
30], [106, 107], [83, 82], [91, 79], [0, 1], [56, 52], [90, 75], [126, 112], [36, 32], [46,
47], [77, 78], [97, 98], [17, 12], [119, 120], [22, 23], [24, 25], [43, 34], [42, 41], [40,
39], [37, 38], [125, 124], [50, 51], [18, 19]]
ZZ_layers = [ZZ_layer1,ZZ_layer2,ZZ_layer3]
nlayers = 16
for k in range(nlayers):

print(“==============”)
print(k)
c = k % 4
if c == 0:

for i in range(n):

gate = Gate(“X_rotation”,i)
Ps.propagate(circuit,gate)

else:

print(“--”)
layer = ZZ_layers[c-1]
for support in layer:

# print(support)
gate = Gate(“ZZ_rotation”, support)
Ps.propagate(circuit,gate)

print(Ps.strings.shape[0])
print(np.sum(np.abs(Ps.coeffs)))
print(Ps.chop(0.001))
Ps_truncated = Ps.truncate(0.01)
print(len(Ps_truncated.strings))
# print(Ps.chop(threshold = 0.001))
plist = Ps.print_strings_long( )
op = PauliList(plist)
groups = op.group_commuting(qubit_wise = True)
print(len(groups))
plist = Ps_truncated.print_strings_long( )
op = PauliList(plist)
groups = op.group_commuting(qubit_wise = True)
print(len(groups))
# print(Ps.coeffs)

# print(np.sort(Ps.coeffs))
a = [1,2,3,4]
b = [1,2]
print(list(set(a)-set(b)))

What is claimed is:

1. A system, comprising:
a memory that stores computer-executable components; and
a processor that executes the computer-executable components stored in the memory, wherein the computer-executable components comprise:
a quantum computation component that applies state propagation to a first part of a quantum circuit, on a quantum computer; and
a classical computation component that applies observable backpropagation to a second part of the quantum circuit, on a high-performance classical computer.

2. The system of claim 1, further comprising:
a division component that divides the quantum circuit into the first part and the second part.

3. The system of claim 1, wherein applying the state propagation comprises preparing a quantum state corresponding to the first part of the quantum circuit.

4. The system of claim 1, wherein applying the observable backpropagation comprises computing an effective observable evolved under the second part of the quantum circuit.

5. The system of claim 4, further comprising:
a measurement component that measures the effective observable with respect to a quantum state corresponding to a first part of the quantum circuit to generate an outcome.

6. The system of claim 5, further comprising:
a post processing component that processes the outcome to obtain an observable expectation value for the quantum circuit.

7. The system of claim 1, wherein applying the state propagation to the first part of the quantum circuit and the observable backpropagation to the second part of the quantum circuit increase an effective depth of the quantum circuit.

8. A computer-implemented method, comprising:
applying, by a system operatively coupled to a processor, state propagation to a first part of a quantum circuit, on a quantum computer; and
applying, by the system, observable backpropagation to a second part of the quantum circuit, on a high-performance classical computer.

9. The computer-implemented method of claim 8, further comprising:
dividing, by the system, the quantum circuit into the first part and the second part.

10. The computer-implemented method of claim 8, wherein applying the state propagation comprises preparing a quantum state corresponding to the first part of the quantum circuit.

11. The computer-implemented method of claim 8, wherein applying the observable backpropagation comprises computing an effective observable evolved under the second part of the quantum circuit.

12. The computer-implemented method of claim 11, further comprising:
measuring, by the system, the effective observable with respect to a quantum state corresponding to a first part of the quantum circuit to generate an outcome.

13. The computer-implemented method of claim 12, further comprising:
processing, by the system, the outcome to obtain an observable expectation value for the quantum circuit.

14. The computer-implemented method of claim 8, wherein applying the state propagation to the first part of the quantum circuit and the observable backpropagation to the second part of the quantum circuit increases an effective depth of the quantum circuit.

15. A computer program product for improving a depth of a quantum simulation using observable backpropagation, the computer program product comprising a computer readable storage medium having program instructions embodied therewith, the program instructions executable by a processor to cause the processor to:
apply, by the processor, state propagation to a first part of a quantum circuit, on a quantum computer; and
apply, by the processor, the observable backpropagation to a second part of the quantum circuit, on a high-performance classical computer.

16. The computer program product of claim 15, wherein the program instructions are further executable by the processor to cause the processor to:
divide, by the processor, the quantum circuit into the first part and the second part.

17. The computer program product of claim 15, wherein applying the state propagation comprises preparing a quantum state corresponding to the first part of the quantum circuit.

18. The computer program product of claim 15, wherein applying the observable backpropagation comprises computing an effective observable evolved under the second part of the quantum circuit.

19. The computer program product of claim 18, wherein the program instructions are further executable by the processor to cause the processor to:
measure, by the processor, the effective observable with respect to a quantum state corresponding to a first part of the quantum circuit to generate an outcome.

20. The computer program product of claim 19, wherein the program instructions are further executable by the processor to cause the processor to:
process, by the processor, the outcome to obtain an observable expectation value for the quantum circuit.
